(19) United States
(12) Patent Application Publication
(10) Pub. No.: US 2014/0369336 A1
(43) Pub. Date: Dec. 18, 2014

(54) APPARATUS AND METHOD FOR DISTRIBUTED UPDATING OF A SELF ORGANIZING NETWORK

(71) Applicant: QUALCOMM Incorporated, San Diego, CA (US)

(72) Inventors: Rajat PRAKASH, San Diego, CA (US); Mehmet YAVUZ, San Diego, CA (US); Chirag Sureshbhai PATEL, San Diego, CA (US); Christophe CHEVALLIER, San Diego, CA (US); Andrea GARAVAGLIA, Nuremberg (DE); Amer CATOVIC, Carlsbad, CA (US); Flavio DE ANGELIS, San Diego, CA (US)

(21) Appl. No.: 14/472,257

(22) Filed: Aug. 28, 2014

Related U.S. Application Data
(63) Continuation-in-part of application No. 12/761,189, filed on Apr. 15, 2010.
(60) Provisional application No. 61/176,644, filed on May 8, 2009.
(60) Provisional application No. 61/885,355, filed on Oct. 1, 2013.

(51) Int. Cl. H04W 24/02; H04W 16/18

(52) U.S. Cl. CPC H04W 24/02; H04W 16/18; H04W 84/18
USPC 370/338

(57) ABSTRACT

The present disclosure presents a method and an apparatus for distributed updating of a self organizing network. For example, the disclosure presents a method for transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations, receiving feedback, from the network entity, associated with one or more network parameters of the base station, wherein the feedback received from the network entity is determined at the network entity at least based on the portion of data transmitted from the one or more base stations to the network entity, and updating the one or more network parameters at the base station based on the feedback received from the network entity and local information at the base station. As such, distributed updating of a self organizing network may be achieved.

### CLAIM OF PRIORITY

The present application for patent is a continuation-in part of patent application Ser. No. 12/761,189 entitled “Method and Apparatus for Generating and Exchanging Information for Coverage Optimization in Wireless Networks,” filed Apr. 15, 2010, pending, assigned to the assignee hereof and hereby expressly incorporated by reference herein, and which claims priority to Provisional Application No. 61/176,644 entitled “Method and Apparatus for Generating and Exchanging Information for Coverage Optimization in Wireless Networks,” filed May 8, 2009.

Additionally, this application claims priority to Provisional Application No. 61/885,355 entitled “Apparatus and Method for Distributed Optimization of a Self Organizing Network,” filed Oct. 1, 2013, assigned to the assignee hereof and hereby expressly incorporated by reference herein.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

To supplement conventional base stations, additional restricted power or restricted coverage base stations, referred to as small coverage base stations or cells, can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power or small coverage (e.g., relative to macro network base stations or cells) base stations can be connected to the Internet via broadband connection (e.g., digital subscriber line (DSL) router, cable or other modem, etc.), which can provide the backhaul link to the mobile operator's network. Thus, for example, the small coverage base stations can be deployed in user homes to provide mobile network access to one or more devices via the broadband connection. Because deployment of such base stations is unplanned, low power base stations can interfere with one another where multiple stations are deployed within a close vicinity of one another.

For example, transmit power management of small cells can help improve capacity and coverage, and is recognized as part of “Capacity and Coverage Optimization” framework in LTE, and is defined in 3GPP as a centralized self organizing network function that may be located within a central network server. The centralized framework may benefit from information gathered over a wider area and from wide number of sources, including reports from eNBs and reports from UEs via Minimization of Drive Test (MDT) procedures. The centralized self organizing network function may reduce the transmit power of cells if it can reduce the interference and improve signal to interference plus noise ratio (SINR) without compromising the coverage. The MDT feature allows the central SON server to track coverage holes in the network, while the measurement reports from UE allow tracking of SINR. For faster responsiveness and more scalability with small cell density, there is a need for better coordination among the centralized and distributed design options.

Thus, there is a desire for a method and an apparatus for distributed updating of a self organizing network.

### SUMMARY

Various aspects are now described with reference to the drawings. In the following description, for purposes of explanation, numerous specific details are set forth in order to provide a thorough understanding of one or more aspects. It may be evident, however, that such aspect(s) may be practiced without these specific details. The following presents a simplified summary of one or more aspects in order to provide a basis understanding of such aspects.

The present disclosure presents an example method and apparatus for distributed updating of a self organizing network. For example, the present disclosure presents an example method for transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations, receiving feedback, from the network entity, associated with one or more network parameters of the base station, wherein the feedback received from the network entity is determined at the network entity at least based on the portion of data transmitted from the one or more base stations to the network entity, and updating the one or more network parameters at the base station based on the feedback received from the network entity and local information at the base station.

In an additional aspect, an apparatus for distributed updating of a self organizing network is disclosed. For example, the apparatus may include means for transmitting a portion of data collected at the base station to a network entity, wherein the data collected at the base station is received by the base station from one or more user equipments (UE) in communication with one or more base stations, wherein the base station is one of the one or more base stations, means for receiving feedback, from the network entity, associated with one or more network parameters of the base station, wherein the feedback received from the network entity is determined at the network entity at least based on the portion of data transmitted from the one or more base stations to the network entity, and means for updating the one or more network parameters at the base station based on the feedback received from the network entity and local information at the base station.

In a further aspect, a computer program product for distributed updating of a self organizing network is disclosed. For example, the computer program product may include a computer-readable medium comprising code executable by a computer for transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations, receiving feedback, from the network entity, associated with one or more network parameters of the base station, wherein the feedback received from the network entity is determined at the network entity at least based on the portion of data transmitted from the one or more base stations to the network entity, and updating the one or more network parameters at the base station based on the feedback received from the network entity and local information at the base station

Moreover, the present disclosure presents an apparatus for distributed updating of a self organizing network. For example, the apparatus may include a data transmitting component to transmit a portion of data collected at the base station to a network entity, wherein the data collected at the base station is received by the base station from one or more user equipments (UE) in communication with one or more base stations, wherein the base station is one of the one or more base stations, a feedback receiving component to receive feedback, from the network entity, associated with one or more network parameters of the base station, wherein the feedback received from the network entity is determined at the network entity at least based on the portion of data transmitted from the one or more base stations to the network entity, and a parameter updating component to update the one or more network parameters at the base station based on the feedback received from the network entity and local information at the base station.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects can be employed and the described aspects are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a wireless network environment that can be employed in conjunction with the various systems and methods described herein.

FIG. 3 illustrates a communication system that enables deployment of access point base stations within a network environment.

FIG. 4 is an overview of an environment that facilitates a distributed coverage optimization in accordance with an aspect of the subject specification.

FIG. 5 illustrates a block diagram of a self-optimization unit that facilitates a distributed coverage optimization in accordance with an aspect of the subject specification.

FIG. 6 is an illustration of a coupling of electrical components that effectuate a distributed coverage optimization according to an aspect.

FIG. 7 is a flow chart illustrating a methodology for performing a self-optimization in accordance with an aspect of the subject specification.

FIG. 8 is a flow chart illustrating a methodology for disseminating a coverage report in accordance with an aspect of the subject specification.

FIG. 9 is a block diagram illustrating an example wireless system in aspects of the present disclosure.

FIG. 10 is a block diagram illustrating an example distributed updating manager in accordance with various aspects described herein.

FIG. 11 is a flow diagram illustrating an example of a method for distributed updating in accordance with various aspects described herein.

FIG. 12 is a block diagram illustrating an example of a logical grouping of electrical components in accordance with various aspects described herein.

FIG. 13 illustrates an example of a network that facilitates a distributed coverage optimization according to an aspect described herein.

FIG. 14 is an illustration of an example of a communication system implemented in accordance with various aspects described herein.

FIG. 15 is an illustration of an example of a base station in accordance with various aspects described herein.

FIG. 16 is an illustration of an example of a wireless terminal implemented in accordance with various aspects described herein.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

In an aspect, the present disclosure provides a method and an apparatus for distributed updating of a self organizing network. For example, a base station may collect data from UEs in communication with the base station and/or neighboring base stations. The base station may transmit a portion of this data (for example, aggregated samples or a report) to a network entity. In an aspect, the network entity may receive such information from one or more base stations in a self organizing network of the base station. The network entity determines feedback for the base station based on the data received from the base station (and other base stations), and may transmit a minimum value, a maximum value, and/or a range of values to the base station. For example, the network entity may provide feedback to the base station to update the transmit power of the base station to at least 200 mW. In additional to the feedback received from the network entity (e.g., to update the transmit power to at least 200 mW), the base station may use local information available at the base station and may update the transmit power to a value, e.g., 220 mW.

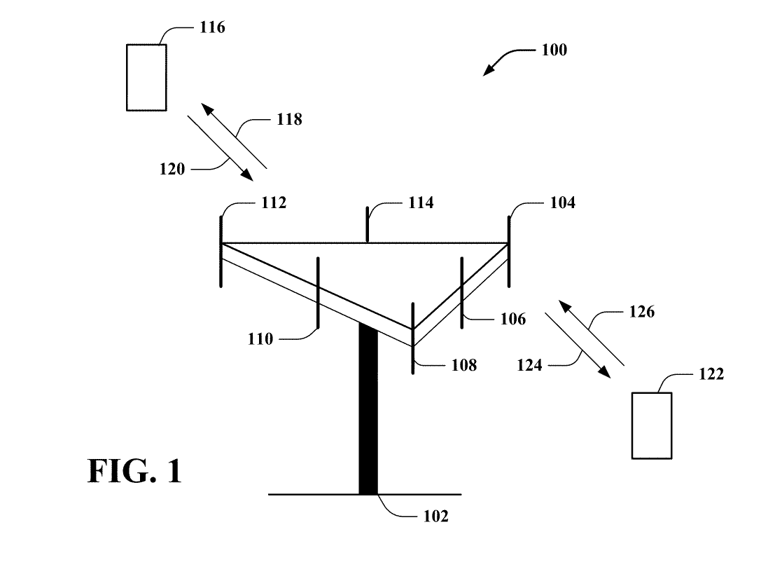

Referring now to FIG. 1, a wireless communication system 100 is illustrated in accordance with various aspects presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more access terminals such as access terminal 116 and access terminal 122; however, it is to be appreciated that base station 102 can communicate with substantially any number of access terminals similar to access terminals 116 and 122. Access terminals 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, access terminal 116 is in communication with antennas 112 and 114, where antennas 112 and 114 transmit information to access terminal 116 over a forward link 118 and receive information from access terminal 116 over a reverse link 120. Moreover, access terminal 122 is in communication with antennas 104 and 106, where antennas 104 and 106 transmit information to access terminal 122 over a forward link 124 and receive information from access terminal 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to access terminals in a sector of the areas covered by base station 102. In communication over forward links 118 and 124, the transmitting antennas of base station 102 can utilize beamforming to improve signal-to-noise ratio of forward links 118 and 124 for access terminals 116 and 122. Also, while base station 102 utilizes beamforming to transmit to access terminals 116 and 122 scattered randomly through an associated coverage, access terminals in neighboring base stations can be subject to less interference as compared to a base station transmitting through a single antenna to all its access terminals.

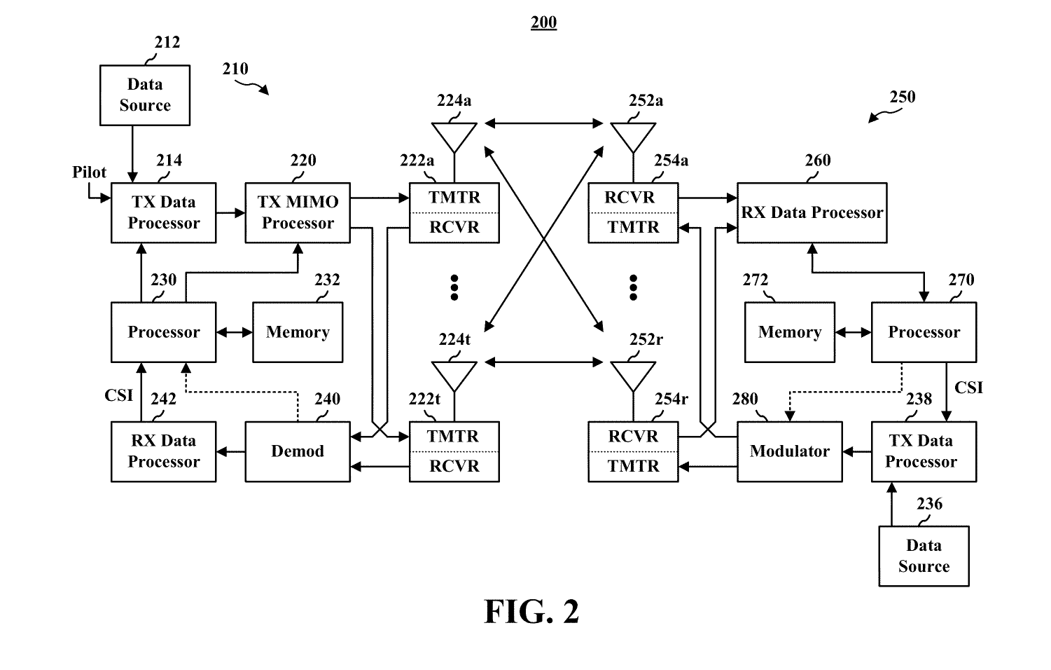

FIG. 2 shows an example wireless communication system 200. The wireless communication system 200 depicts one base station 210 and one access terminal or user equipment (UE) 250 for sake of brevity. However, it is to be appreciated that system 200 can include more than one base station and/or more than one access terminal, wherein additional base stations and/or access terminals can be substantially similar or different from example base station 210 and access terminal 250 described below. In addition, it is to be appreciated that base station 210 and/or access terminal 250 can employ the systems and/or methods described herein to facilitate wireless communication there between.

At base station 210, traffic data for a number of data streams is provided from a data source 212 to a transmit (TX) data processor 214. According to an example, each data stream can be transmitted over a respective antenna. TX data processor 214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In various aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 222a through 222t are transmitted from N_{T} antennas 224a through 224t, respectively.

At access terminal 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective signal, digitizes the conditioned signal to provide samples, and further processes the samples to provide a corresponding “received” symbol stream.

An RX data processor 260 can receive and process the N_{R} received symbol streams from N_{R} receivers 254 based on a particular receiver processing technique to provide N_{T} “detected” symbol streams. RX data processor 260 can demodulate, deinterleave, and decode each detected symbol stream to recover the traffic data for the data stream. The processing by RX data processor 260 is complementary to that performed by TX MIMO processor 220 and TX data processor 214 at base station 210.

A processor 270 can periodically determine which available technology to utilize as discussed above. Further, processor 270 can formulate a reverse link message comprising a matrix index portion and a rank value portion.

The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from access terminal 250 are received by antennas 224, conditioned by receivers 222, demodulated by a demodulator 240, and processed by a RX data processor 242 to extract the reverse link message transmitted by access terminal 250. Further, processor 230 can process the extracted message to determine which precoding matrix to use for determining the beamforming weights.

Processors 230 and 270 can direct (e.g., control, coordinate, manage, etc.) operation at base station 210 and access terminal 250, respectively. Respective processors 230 and 270 can be associated with memory 232 and 272 that store program codes and data. Processors 230 and 270 can also perform computations to derive frequency and impulse response estimates for the uplink and downlink, respectively.

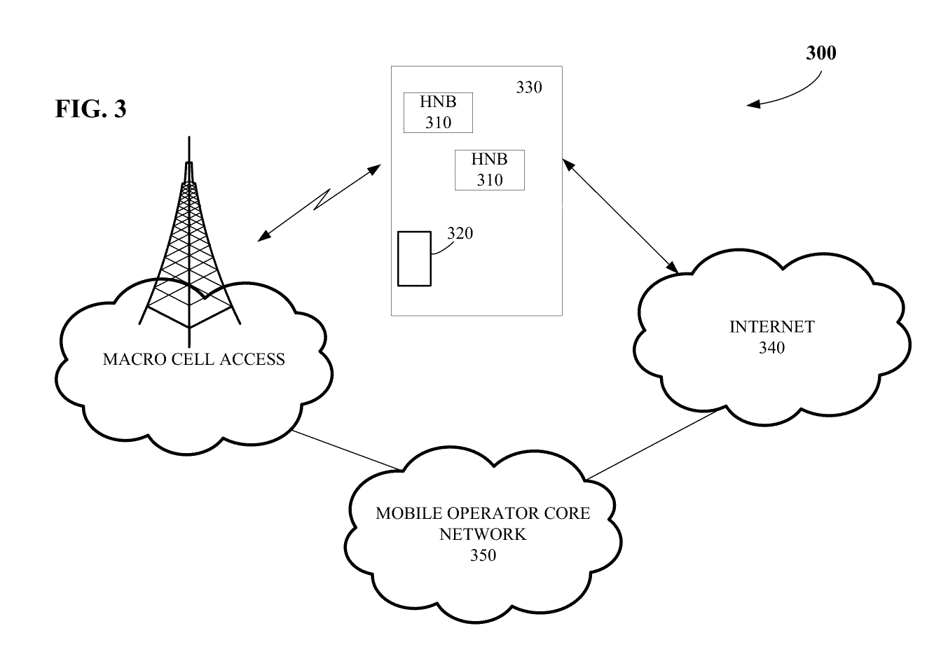

FIG. 3 illustrates an example communication system to enable deployment of access point base stations within a network environment. As shown in FIG. 3, the system 300 includes multiple access point base stations or, in the alternative, femto cells, Home Node B units (HNBs), or Home evolved Node B units (HeNBs), such as, for example, HNBs 310, each being installed in a corresponding small scale network environment, such as, for example, in one or more user residences 330, and being configured to serve associated, as well as alien, user equipment (UE) or mobile stations 320. Each HNB 310 is further coupled to the Internet 340 and a mobile operator core network 350 via a DSL router (not shown) or, alternatively, a cable modem (not shown).

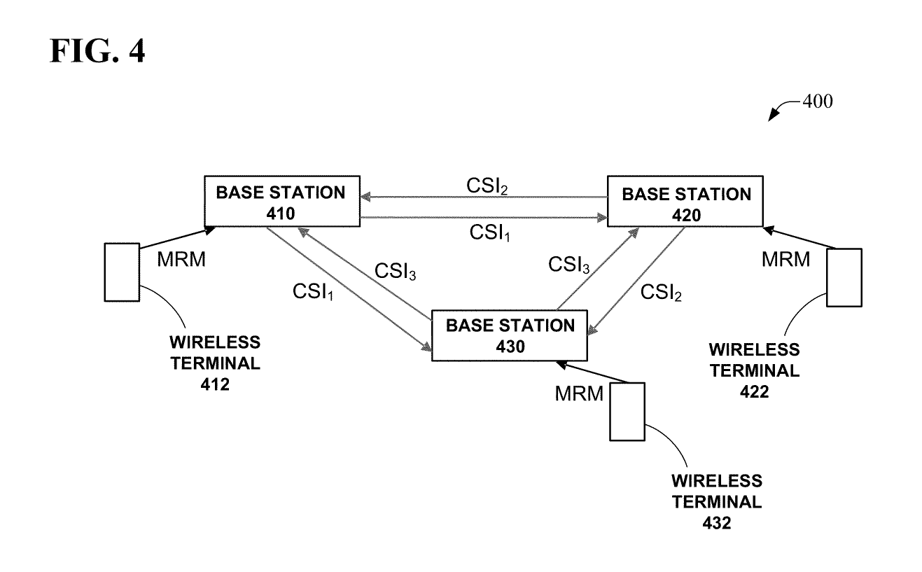

The subject specification is generally directed towards various aspects for facilitating a distributed coverage optimization. In particular, aspects are disclosed which are directed towards an information exchange concept for purposes of automatic distributed CCO, semantics of the information being exchanged, and a method for computing the information to be exchanged. To this end, an overview of an example system that facilitates a distributed coverage optimization in accordance with an aspect of the subject specification is provided in FIG. 4. As illustrated, system 400 includes a plurality of base stations 410, 420, 430, which respectively serve wireless terminals 412, 422, 432. For this particular aspect, information is exchanged between base stations 410, 420, 430 for purposes of CCO. In an aspect, base stations 410, 420, 430 exchange information directly about long-term coverage statistics in the cells they parent. Within such aspect, the statistics reflect measurements collected by base stations 410, 420, 430 and/or by wireless terminals 412, 422, 432, which are connected to the cells parented by base stations 410, 420, 430. In a particular aspect, information is packed into a specific message (e.g., CSI—Coverage Statistics Information, which is a generic name used herein) to be exchanged between eNBs using standardized protocols, such as X2 AP (3GPP TS 36.423) or S1 AP (TS 36.421). Here, it should be noted that information can be exchanged via any of a plurality of mechanisms including, for example, periodically (where the period may be configurable by a network operator), per request by a base station, and/or triggered by particular configurable events (e.g. when a load in a cell exceeds a certain threshold, etc.).

With respect to semantics, it should be noted that an eNB can exchange coverage-related statistics which reflect any of a plurality of characteristics. For instance, in an aspect, such statistics may reflect downlink/uplink coverage quality in a cell, received downlink/uplink power, received downlink/uplink interference power, received downlink interference power from a specific neighbor, UE transmit power level, cell geometry, and/or path loss in a cell.

In a further aspect, coverage-related statistics are computed using either internal eNB measurements and/or UE measurement report messages (MRMs), wherein a time scale over which the statistics are computed can be configured by a network operator. In a particular aspect, the coverage-related statistics are computed over a sufficiently long time period to cover any of a plurality of variations including, for example, variations in UE geographical distributions, loading of the serving cell and neighboring cells, and/or UE mobility patterns.

Here, it should be noted that the method to compute coverage statistics exchanged between eNBs can be standardized. For instance, the definition of each statistics exchanged can be standardized. Another approach, however, is to have the method for computing coverage statistics not standardized. For example, average cell geometry can be defined as a number between 0 and 1, where a lower number is associated with a lower geometry. For this aspect, an eNB can then simply indicate its average geometry as 0.5, without indicating how it is computed. Similarly, an eNB parenting a cell i can advertise an interference coefficient IC_{i,j} to describe a level of interference received in cell i from cell j (e.g., IC_{i,j}=0.5), without specifying how it is computed. In this case, what may be standardized is the semantics (e.g., meaning) of each statistic and its range (e.g., 0 to 1).

As stated previously, an eNB can compute coverage statistics from internal measurements and/or UE MRMs. As per a serving cell and/or neighbor cell, an eNB can configure UEs served by that eNB to collect and report measurements of signal quality. In an aspect, a UE can measure and report signal quality of a serving cell as well as of neighboring cells. For instance, an eNB can configure UEs to measure and report a Reference Signal Received Power (RSRP) level of a serving cell and/or neighbor cell, a Reference Signal Received Quality (RSRQ) level of a serving cell and/or neighbor cell, a Radio Signal Strength Indication (RSSI) level, a UE transmit power level, other measurements specified by a particular protocol (e.g., 3GPP TS 36.423). Here, it should also be noted that measurement reports can be configured as periodical and/or triggered.

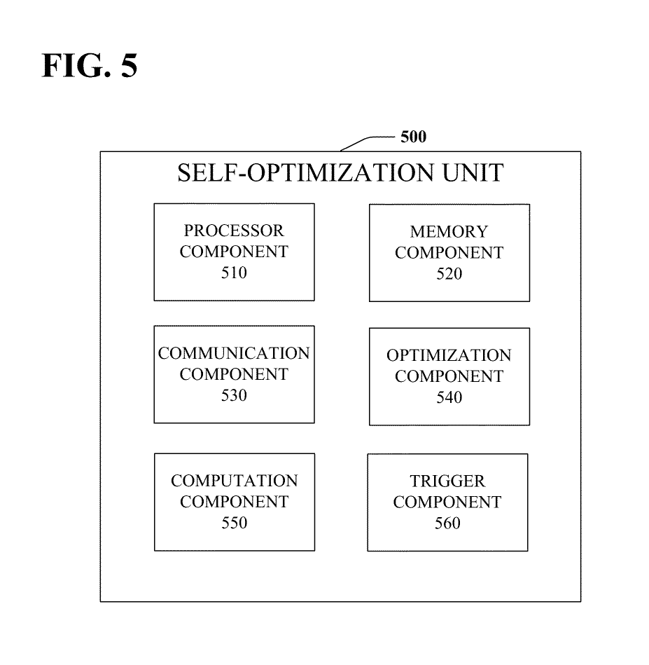

Referring next to FIG. 5, a block diagram of a self-optimization unit that facilitates a distributed coverage optimization according to an aspect is provided. As shown, self-optimization unit 500 may include processor component 510, memory component 520, communication component 530, optimization component 540, computation component 550, and trigger component 560. Here, it should be appreciated that self-optimization unit 500 may reside in a base station (e.g., eNB) or access point base station (e.g., HeNB), for instance.

In one aspect, processor component 510 is configured to execute computer-readable instructions related to performing any of a plurality of functions. Processor component 510 can be a single processor or a plurality of processors dedicated to analyzing information to be communicated from self-optimization unit 500 and/or generating information that can be utilized by memory component 520, communication component 530, optimization component 540, computation component 550, and/or trigger component 560. Additionally or alternatively, processor component 510 may be configured to control one or more components self-optimization unit 500.

In another aspect, memory component 520 is coupled to processor component 510 and configured to store computer-readable instructions executed by processor component 510. Memory component 520 may also be configured to store any of a plurality of other types of data including data generated by any of communication component 530, optimization component 540, computation component 550, and/or trigger component 560. Memory component 520 can be configured in a number of different configurations, including as random access memory, battery-backed memory, hard disk, magnetic tape, etc. Various features can also be implemented upon memory component 520, such as compression and automatic back up (e.g., use of a Redundant Array of Independent Drives configuration).

In another aspect, communication component 530 is also coupled to processor component 510 and configured to interface self-optimization unit 500 with external entities. For instance, communication component 530 may be configured to receive coverage-related measurements from external entities, and to report coverage reports generated by computation component 550. Here, it should be noted that such external entities may include wireless terminals and/or base stations, wherein communication component is configured to facilitate particular communications. For example, with respect to wireless terminals, communication component 530 may be further configured to provide wireless terminals with configuration data so as to configure the wireless terminals to collect particular coverage-related measurements. With respect to base stations, however, communication component 530 may be further configured to facilitate a backhaul connection with particular base stations (e.g., via an S1 or X2 interface).

As illustrated, self-optimization unit 500 may further include optimization component 540 and computation component 550. Within such aspect, optimization component 540 is configured to self-optimize a coverage parameter as a function of at least one coverage-related measurement, whereas computation component 550 is configured to provide a coverage report based on the at least one coverage-related measurement. In a particular aspect, computation component 550 is further configured to determine a set of coverage-related statistics to include in the coverage report. It should be noted that the set of coverage-related statistics may be associated with any of a plurality of characteristics including, for example, a coverage quality (e.g., a downlink/uplink coverage quality in a cell), a received power (e.g., a received downlink/uplink power), a received interference power (e.g., a received downlink/uplink interference power), a received downlink interference power from a specific neighbor, a user equipment transmit power, a cell geometry, and/or a path loss in a cell.

In a further aspect, computation component 550 is configured to compute the set of coverage-related statistics across the at least one coverage-related measurement. For instance, computation component 550 may be configured to compute an average, a maximum, and/or a minimum across the at least one coverage-related measurement. Within such aspect, computation component 550 may be further configured to perform such computations across any of a plurality of coverage-related measurements, wherein such measurements may be associated with a serving cell and/or a neighboring cell. For instance, it is contemplated that coverage-related measurements may include a reference signal received power, a reference signal received quality, a reference signal strength indication, and/or a user equipment transmit power. Computation component 550 may also configured to perform an averaging of a cell geometry, a path loss in a cell, and/or a signal-to-noise ratio requirement of a user equipment. In another aspect, computation component 550 is further configured to compute an interference coefficient associated with at least one neighbor cell.

Here, it is noted that the coverage report provided by computation component 550 is associated with a coverage provided by at least one cell. For instance, the at least one cell can be a serving cell, a neighboring cell, and/or an extended neighbor cell. Here, with respect to extended neighbor cells, the coverage report may be configurable by a network entity (e.g., a radio resource controller) to include coverage information associated with a particular set of extended neighbor cells. For example, the network entity may dictate that the coverage report be based on coverage-related measurements relating to a set of extended neighbor cells within a threshold number of hops from a serving cell.

In a further aspect, the coverage report generated by computation component 550 can be disseminated to external entities. For instance, communication component 530 may be further configured to communicate the coverage report to a base station. In a particular aspect, the coverage report is included in a series of coverage reports, wherein communication component 530 is configured to report the series of coverage reports based on a period. Within such aspect, the period can be configurable by a network entity. In another aspect, communication component 530 is configured to communicate the coverage report based on a trigger event (e.g., a request for the coverage report) detected by trigger component 560. For this aspect, trigger component 560 is thus configured to detect any of a plurality of trigger events including, for example, a request for the coverage report, a determination of whether a load in a cell exceeds a threshold, etc.

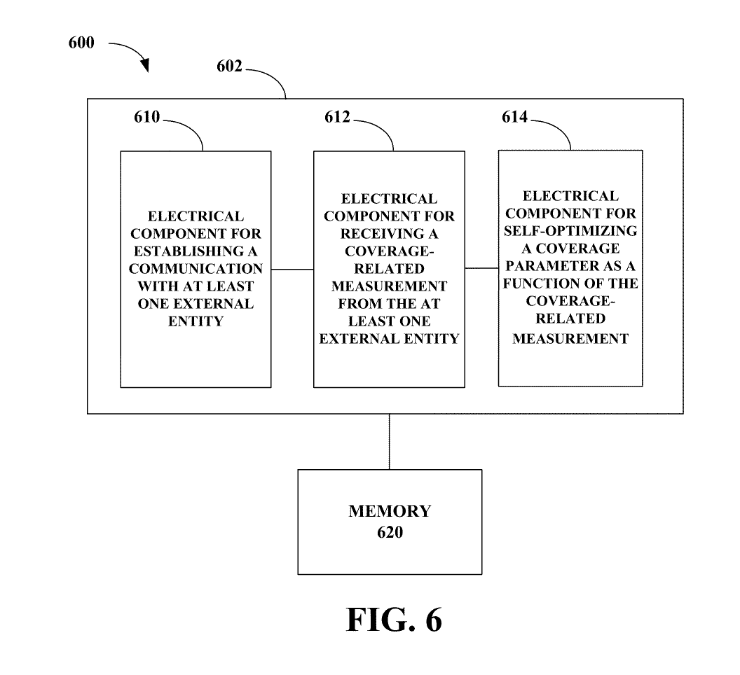

Referring next to FIG. 6, illustrated is a system 600 that facilitates a distributed coverage optimization according to an aspect. System 600 can reside within a base station (e.g., an eNB, HeNB, etc.), for instance. System 600 includes functional blocks that can represent functions implemented by a processor, software, or combination thereof (e.g., firmware), wherein system 600 includes a logical grouping 602 of electrical components that can act in conjunction. As illustrated, logical grouping 602 can include an electrical component for establishing a communication with at least one external entity 610. Furthermore, logical grouping 602 can include an electrical component for receiving a coverage-related measurement from the at least one external entity 612. Logical grouping 602 can also include an electrical component for self-optimizing a coverage parameter as a function of the coverage-related measurement 614. Additionally, system 600 can include a memory 620 that retains instructions for executing functions associated with electrical components 610, 612, and 614. While shown as being external to memory 620, it is to be understood that electrical components 610, 612, and 614 can exist within memory 620.

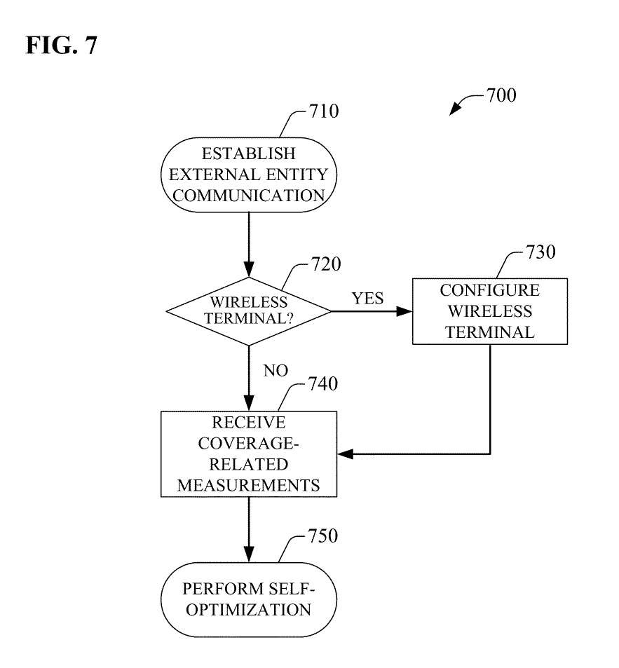

Referring next to FIG. 7, a flow chart illustrating an example method for performing a self-optimization according to an aspect is provided. As illustrated, process 700 includes a series of acts that may be performed by a base station (e.g., eNB, HeNB, etc.) according to an aspect of the subject specification. For instance, process 700 may be implemented by employing a processor to execute computer executable instructions stored on a computer readable storage medium to implement the series of acts. In another aspect, a computer-readable storage medium comprising code for causing at least one computer to implement the acts of process 700 are contemplated.

In an aspect, process 700 begins at act 710 with an external entity communication being established. As stated previously, such communication can be a communication with a wireless terminal or base station, for example. Upon establishing the communication, a determination of whether the external entity is a wireless terminal is performed at act 720. If the external entity is indeed a wireless terminal, process 700 proceeds by configuring the wireless terminal at act 730, wherein coverage-related measurements are then subsequently received from the wireless terminal at act 740. Otherwise, if the external entity is not a wireless terminal, process 700 proceeds directly to act 740 where coverage-related measurements are received from a non-wireless terminal external entity (e.g., an eNB serving a neighboring cell). Upon receiving coverage related measurements at act 740, process 700 then concludes at act 750 where a self-CCO is performed based on the received coverage related measurements.

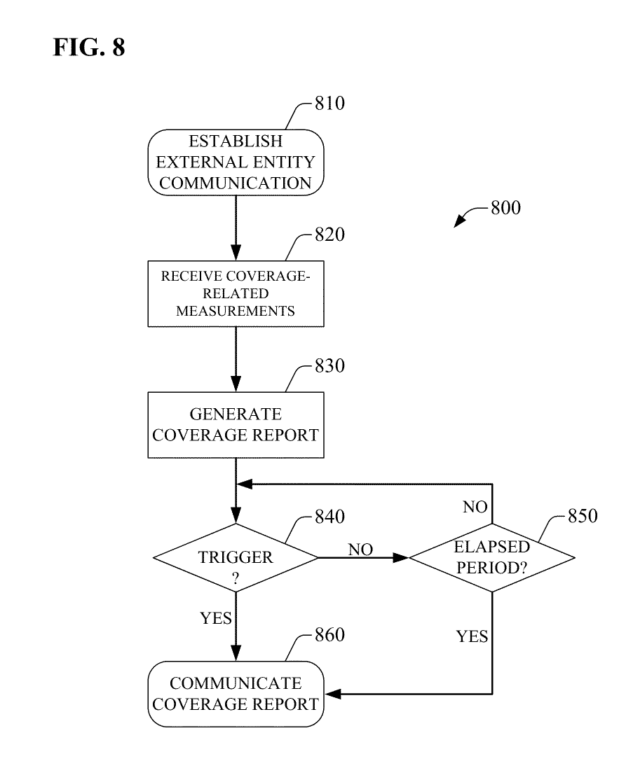

Referring next to FIG. 8, a flow chart illustrating an example method for disseminating a coverage report is provided. As illustrated, process 800 also includes a series of acts that may be performed by a base station (e.g., eNB, HeNB, etc.) according to an aspect of the subject specification. For instance, process 800 may be implemented by employing a processor to execute computer executable instructions stored on a computer readable storage medium to implement the series of acts. In another aspect, a computer-readable storage medium comprising code for causing at least one computer to implement the acts of process 800 are contemplated.

In an aspect, similar to process 700, process 800 begins by having the base station establish a communication with an external entity at act 810. Next, at act 820, coverage-related measurements are received from the external entity (e.g., from a wireless terminal, an eNB, an HeNB, etc.), followed by a generation of a coverage report at act 830 based on the received coverage-related measurements. Process 800 then proceeds to act 840 where a determination is made as to whether a trigger event has occurred. Here, it should be noted that detecting a trigger event at act 840 may include monitoring any of a plurality of trigger events including, for example, monitoring a load in a cell. If a trigger event is indeed detected, process 800 concludes at act 860 where the coverage report is communicated to a base station. Otherwise, if a trigger event is not detected, the reporting of coverage reports can be based on a pre-determined periodicity. For instance, in an aspect, process 800 proceeds to act 850 where an elapsed period determination is made. Here, if the period for communicating the coverage report has elapsed, then process 800 concludes with the coverage report being communicated to a base station at act 850. Otherwise, if the period has not yet elapsed, process 800 loops back to act 840 where trigger events are again monitored.

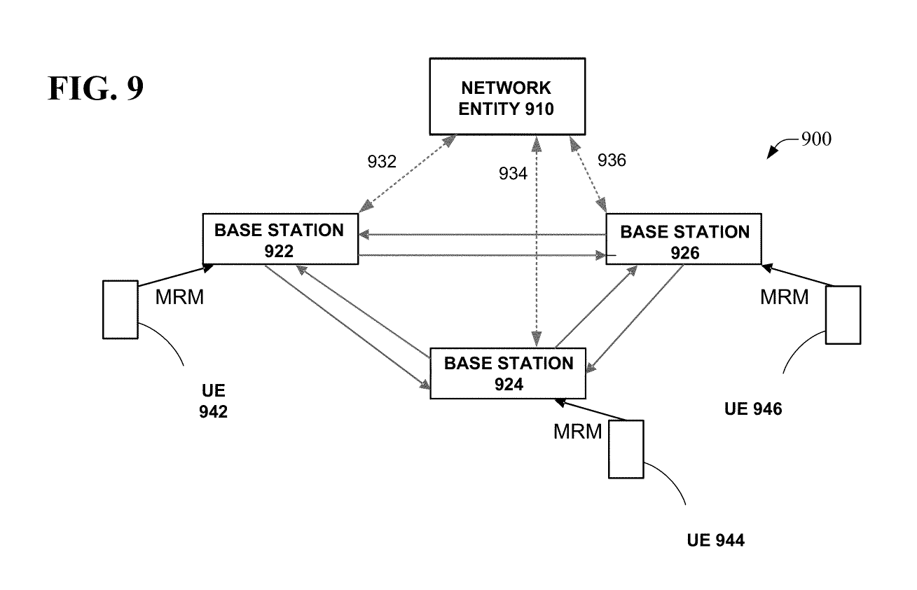

FIG. 9 illustrates a wireless communication system 900 that facilitates distributed updating of a self organizing network (SON) by operation of a distributed updating manager 1002 by one or more base stations of system 900. In this case, the one or more base stations may be defined as the SON.

In an aspect, for example, system 900 may be a communications network with one or more base stations, for example, base stations 922, 924, and/or 926, in communication with a core network entity 910 via one or more communication links, for example, links 932, 934, and/or 936. System 900 may include one or more user equipment (UE), for example, UEs 942, 944, and/or 946. In an aspect, for example, UEs 942, 944, and 946 may be in communication respectively with base stations 922, 924, and 926. In an additional aspect, each of the UEs 942, 944, and 946 may communicate with more than one base station even though a UE is camped on just one base station. In an additional or optional aspect, network entity 910 may reside at one server, or at multiple servers for load sharing and/or redundancy in case of failures.

In an aspect, base stations 922, 924, and/or 926 may be small cells. The term “small cell,” as used herein, refers to a relatively low transmit power and/or a relatively small coverage area cell as compared to a transmit power and/or a coverage area of a macro cell. Further, the term “small cell” may include, but is not limited to, cells such as a femto cell, a pico cell, access point base stations, Home NodeBs, femto access points, or femto cells. For instance, a macro cell may cover a relatively large geographic area, such as, but not limited to, several kilometers in radius. In contrast, a small cell, such as a pico cell, may cover a relatively small geographic area, such as, but not limited to, a building. Alternatively, or in addition, a small cell such as a femto cell also may cover a relatively small geographic area, such as, but not limited to, a home, or a floor of a building.

In an aspect, apparatus and methods for distributed updating of a self organizing network are disclosed. For example, in an aspect, the present apparatus and methods may be directed towards information exchange for purposes of distributed updating of a self organizing network (e.g., distributed Coverage and Capacity Optimization (CCO)), and/or towards semantics of the information being exchanged, and/or towards computing the information to be exchanged, as described above in detail in reference to FIG. 4.

CCO effectively manages the tradeoff between coverage and capacity to assist operators handle dynamic traffic distribution, design faults and real life network operational constraints. For example, base stations' radio frequency (RF) parameters play a key role in capacity and coverage of a radio access network (RAN) performance and, ultimately, on users' Quality of Experience (QoE). Network performance is affected not only by sub-optimal planning but also by the dynamic radio environment and therefore radio parameters should be dynamically updated or adjusted. To assist with this, 3GPP introduced the CCO use case for networks. CCO identifies coverage holes and high overlaps, and automatically performs corrective actions by adjusting the base station's radio controlling parameters.

In an aspect, the present disclosure provides a method and an apparatus for distributed updating of a self organizing network. For example, a base station may update one or more network parameters at the base station based on feedback received from a network entity and local information at the base station. The feedback received at the network entity may be determined at the network entity based on a portion of data transmitted from one or more base station to the network entity.

For example, in an aspect, the feedback received from the network entity at the base station may include a minimum value, a maximum value, or a range of values for one or more network parameters of the base station. For example, the network entity may determine regions of poor coverage, and may determine lower bound (e.g., minimum value) on transmit power of the base station for the base station to provide the appropriate coverage. The base station may update one or more network parameters based on the lower bound value received from the network entity and other local information available at the base station to determine the appropriate transmit power for the base station.

As illustrated in FIG. 9, system 900 includes a plurality of base stations 922, 924, and/or 926, which respectively serve UEs 942, 944, and/or 946, and which each include a distributed updating manager 1002 to perform the functions described herein. For example, in an aspect, distributed updating manager 1002 may be configured to exchange information between base stations 922, 924, and/or 926 for purposes of CCO. In an aspect, base stations 922, 924, and/or 926 exchange information directly about long-term coverage statistics in the cells they operate. In such an aspect, the statistics reflect measurements collected by base stations 922, 924, and/or 926 and/or by wireless terminals 942, 944, and/or 946, which are connected to the cells operated by base stations 922, 924, and/or 926.

For example, in an aspect with respect to information exchange, distributed updating manager 1002 may include information in a specific message (e.g., CSI—Coverage Statistics Information, which is a generic name used herein) to be exchanged between base stations using standardized protocols, such as X2 AP (3GPP TS 36.423) or S1 AP (3GPP TS 36.421). In an aspect, distributed updating manager 1002 may exchange information via any of a plurality of mechanisms including, for example, periodically (where the period may be configurable by a network operator), per request by a base station, and/or triggered by particular configurable events (e.g. when a load on a base station or a cell exceeds a certain threshold, etc.).

In an aspect, with respect to semantics, it should be noted that distributed updating manager 1002 may cause a base station to exchange coverage-related statistics which reflect any of a plurality of characteristics. For example, in an aspect, such statistics may reflect one or more of downlink/uplink coverage quality in a cell, received downlink/uplink power, received downlink/uplink interference power, received downlink interference power from a specific neighbor, UE transmit power level, cell geometry, and/or path loss in a cell.

In a further aspect, distributed updating manager 1002 may compute coverage-related statistics using either internal base station measurements and/or UE measurement report messages (MRMs), wherein a time scale over which the statistics are computed may be configured by a network operator. For example, in an aspect, the coverage-related statistics may be computed over a sufficiently long time period to cover any of a plurality of variations including, for example, one or more of variations in UE geographical distributions, loading of the serving cell and neighboring cells, and/or UE mobility patterns.

In an aspect, each distributed updating manager 1002 may include a standardized mechanism to compute coverage statistics exchanged between base stations. For example, the definition of each statistic exchanged may be standardized. In an alternative or additional aspect, however, the method for computing one or more coverage statistics may not be standardized. For example, in an aspect, average cell geometry can be defined as a number between 0 and 1, where a lower number is associated with a lower geometry. For this aspect, a base station through operation of distributed updating manager 1002 can then simply indicate its average geometry as 0.5, without indicating how it is computed. Similarly, a base station operating a cell ‘i’ can advertise an interference coefficient ICi,j to describe a level of interference received in cell i from cell j (e.g., ICi,j=0.5), without specifying how it is computed. In this case, what may be standardized is the semantics (e.g., meaning) of each statistic and its range (e.g., 0 to 1).

For example, as described above, a base station operating distributed updating manager 1002 may compute coverage statistics from internal measurements and/or UE MRMs. Additionally, a base station operating distributed updating manager 1002 may configure UEs served by that base station to collect and report measurements of signal quality. In an aspect, a UE can measure and report signal quality of a serving cell as well as of neighboring cells. For instance, a base station may configure UEs to measure and report one or more of a Reference Signal Received Power (RSRP) level of a serving cell and/or neighbor cell, a Reference Signal Received Quality (RSRQ) level of a serving cell and/or neighbor cell, a Radio Signal Strength Indication (RSSI) level, a UE transmit power level, and other measurements specified by a particular protocol (e.g., 3GPP TS 36.423). Additionally, it should also be noted that measurement reports may be configured as periodical and/or triggered.

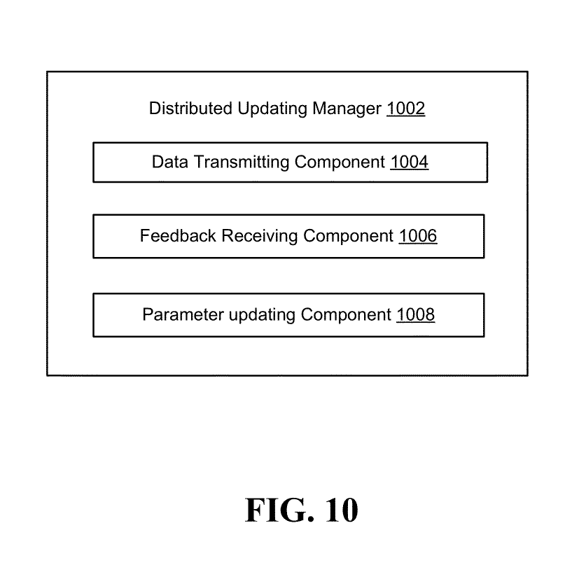

Referring to FIG. 10, an example distributed updating manager 1002 in aspects of the present disclosure is illustrated.

In an aspect, distributed updating manager 1002 may be configured for distributed updating of a self organizing network. For example, in an aspect, each of base stations 922, 924, and/or 926 may be configured to include distributed updating manager 1002. In an additional aspect, distributed updating manager 1002 (of base stations 922, 924, and/or 926) may be configured to further include a data transmitting component 1004, a feedback receiving component 1006, and/or a parameter updating component 1008.

In an aspect, data transmitting component 1004 may be configured to transmit data collected at a base station to a network entity. For instance, data transmitting component 1004 may include or interface with a transceiver or transmitter, and/or may include software or firmware executed by a processor, and/or may include a specially programmed processor module. For example, in an aspect, data transmitting component 1004 may be configured to transmit data collected at base station 922 to network entity 910. In an additional aspect, data transmitting component 1004 may be configured to transmit data collected at base stations 924 and/or 926 to network entity 910. As described above in reference to FIG. 9, data collected at base station 922, 924, and/or 926 may include coverage statistics from internal measurements at the base stations and or MRMs received from the UEs.

For example, in an aspect, the data collected at the base stations may be received at the base stations from user equipments (UE), for example, UEs 942, 944, and/or 946, which may be in communication with the base stations. In an additional aspect, the base station may be a small cell or a macro cell, and/or a combination of both. In an additional example aspect, the network entity 910 may include a central server that receives the data transmitted from the base stations in the self organizing network.

In an aspect, data received from the UEs in communication with a base station may contain thousands of signaling reports. In an alternative or additional aspect, it should be noted that the data received at one base station may include data from one or more neighboring base stations received from UEs communicating with the one or more neighboring base stations. In an aspect, a base station may consolidate the data (for example, signaling reports) received from the UEs and transmit at least a portion of the data to network entity 910, for example, a central server. In an additional aspect, for example, a base station may generate a representation, aggregation, or mathematical function of the data, e.g., an average the signaling information received from the UEs and/or neighboring base stations, and send the representation, aggregation, or mathematical function of the data to network entity 910. For example, this may allow the network entity to have a network wide view, instead of a localized or a limited view maintained by a base station in the SON. For example, in an aspect, the network wide view maintained by network entity 910 may be in the order of 15 minutes and/or up to twenty four hours worth of data, the duration of which may be configurable at network entity 910, for example, by the network operator.

In an aspect, feedback receiving component 1006 may be configured to receive feedback, from the network entity, associated with network parameter(s) of a base station, wherein the feedback received from the network entity is determined at the network entity based on the data transmitted from the one or more base stations to the network entity. In an aspect, network entity 910 may determine the feedback for a base station (e.g., 922) based on the data transmitted to the network entity from the base station (e.g., 922). In an additional aspect, network entity may also consider data received from other base stations (e.g., 924 and/or 926) to determine feedback for the base station (e.g., 922). For instance, in an aspect, feedback receiving component 1006 may include or interface with a transceiver or receiver, and/or may include software or firmware executed by a processor, and/or may include a specially programmed processor module. For example, in an aspect, the feedback received from network entity 910 may be associated with one or more network parameters of a base station, for example, base station 922. In an example aspect, the network parameters may include one or more of a transmit power of the base station, an antenna down tilt at the base station, and a frequency re-use factor at the base station.

For example, in an aspect, network entity 910 may identify coverage gaps in a self organizing network, as per minimization of drive tests (MDT) procedures defined in 3GPP Specifications, based on the data transmitted by the base stations. In an additional aspect, network entity 910 may determine a minimum threshold value for a network parameter of a base station and transmit the minimum threshold value to the base station. For example, in an aspect, base station 922 may receive feedback from network entity 910 to update the transmit power of the base station at a minimum value (for example, 200 mW) to address the coverage gap. In an optional or additional aspect, base station 922 may update the transmit power of base station 922 at or above the minimum threshold value received from the network entity 910.

In an aspect, parameter updating component 1008 may be configured to update the one or more network parameters at the base station based at least on the feedback received from the network entity and local information at the base station. For instance, parameter updating component 1008 may include or interface with a processor, and/or may include software or firmware executed by a processor, and/or may include a specially programmed processor module. For example, in an aspect, parameter updating component 1008 may be configured to update one or more network parameters (e.g., transmit power of a base station, antenna down tilt, and/or frequency re-use factor) at base station 922 based at least on the feedback received from network entity 910 and local information available at base station 922.

For example, base station 922 through operation of parameter updating component 1008 may update the transmit power of base station 922 based on additional data that may be locally available at base station 922, as not all data available at the base station may have been transmitted to network entity 910 to alleviate any bandwidth and/or processing power concerns at the base station and/or the network entity.

In an aspect, the local information may include pilot pollution information at the base station. For example, the pilot pollution information may include number of UEs that report multiple strong interferers (e.g., relatively strong compared to serving cell 922, by about e.g., 5 dB or a configurable threshold value). In an additional aspect, the local information may include number of call failures and/or handover failures measured at the serving base station. For example, if the number of call failures and/or handover failures at base station 922 are high (e.g., above a configurable threshold value), the call failure and/or handover failure reason may be determined from the available local information, and the power at the base station (e.g., base station 922) may be reduced if the call failure and/or handover failure reason is due to increased interference. In an optional aspect, if another base station is not available that meets serving cell selection criteria, the power of the base station (e.g., base station 922) is not reduced.

In an aspect, if there a number of base stations, e.g., small cells, in small coverage area of a SON, it is desirable for only some of the small cells of the SON to be transmitting at their maximum power and the remaining ones of the small cells of the SON transmitting at a lower power (but at or above the minimum threshold values received from the network entity) to reduce interference and/or to improve SINR values. In an additional aspect, once a base station, e.g., a small cell, receives a minimum threshold value for a network parameter from the network entity, the small cell may operate parameter updating component 1008 to further optimize additional parameters, for example, SINR and/or throughout capacity, which may ultimately lead to a better user experience.

For example, in an aspect, if the antenna at a base station, e.g., base station 922, is tilted downwards, the base station may create strong beams and may localize coverage in that area. However, the overall coverage area of the base station may be reduced. Alternatively, if the antenna of the base station, e.g., base station 922, is tilted high or tilted towards the horizon, the base station coverage area may be higher. However, this may result in increased interference with other base stations and/or UEs. For example, the base station, e.g., base station 922, may receive feedback including a minimum value for the antenna down tilt parameter, and the base station operating parameter updating component 1008 may update the down tilt parameter to a value at or above the minimum value based on the additional data that may be locally available at the base station.

In another example aspect, base station, e.g., base station 922, may receive feedback that includes a minimum frequency reuse parameter, which may include a frequency reuse factor, from network entity 910. In this case, the base station may operate parameter updating component 1008 to update the frequency re-use factor, at or above the minimum frequency reuse factor, based on the information locally available at the base station.

In an additional aspect, the feedback including the frequency reuse parameter may include a fractional frequency reuse (FFR) configuration, which may further include assignment of specific prioritized frequency blocks at different base stations. In an additional aspect, soft FFR may include assignment of specific prioritized frequency blocks at different base stations with each prioritized block in a base station having a different transmit power restriction. For example, a higher FFR factor may result in better coverage at a base station, but the base station has to consider the higher interference with the higher re-use factor and select a value that balances both.

In an additional aspect, when the base station receives feedback including a value range for a network parameter, the range may include lower and/or upper limits on frequency reuse factor, restrictions on number of prioritized frequency blocks for FFR or an ordered list of prioritized frequency block, and/or restrictions on the transmit power level specific to a frequency block.

In an additional aspect, for example, SINR, data rate, traffic conditions, specific positions of the UEs (e.g., near the center or edge of the base station) may be known locally at the base station and/or taken into consideration when operating parameter updating component 1008 to update network parameters at the base station for distributed updating of the self organizing network.

In an additional aspect, although the feedback received from the network entity to change one or more network parameters at one or more base stations may be defined in terms of minimum values for simplicity, the feedback received from the network entity may include a maximum value and/or a value range for the respective network parameters.

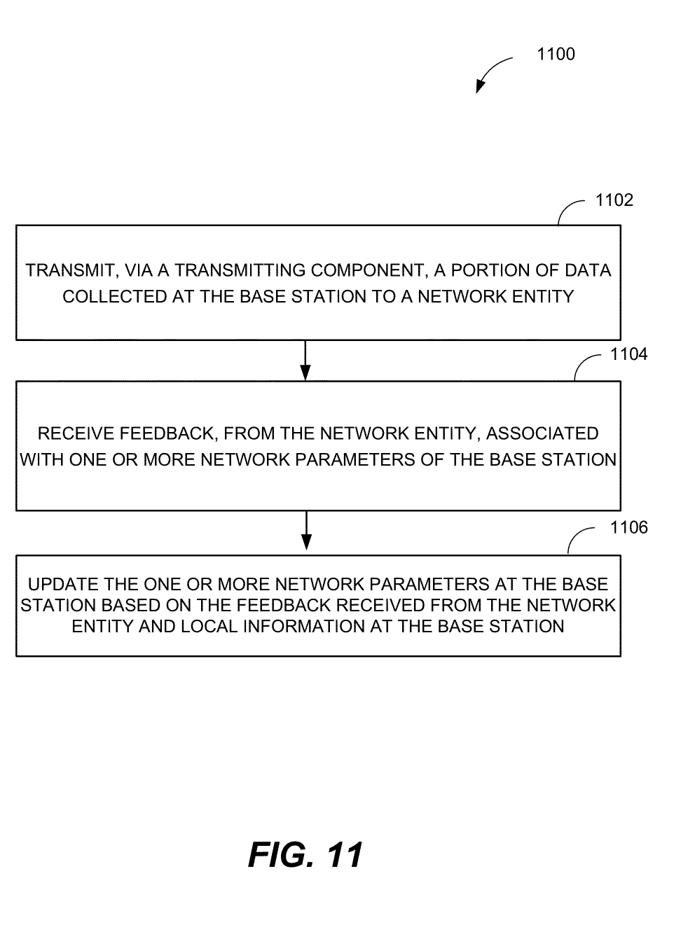

FIG. 11 illustrates an example methodology 1100 for distributed updating of a self organizing network. In an aspect, at block 1102, methodology 1100 may include transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations. For example, in an aspect, base stations 922, 924, and/or 926 may operate distributed updating manager 1002 and/or data transmitting component 1004 to transmit data collected at the base stations to network entity 910.

Further, at block 1104, methodology 1100 may include receiving feedback, from the network entity, associated with one or more network parameters of the base station, wherein the feedback received from the network entity is determined at the network entity at least based on the portion of data transmitted from the one or more base stations to the network entity. For example, in an aspect, base stations 922, 924, and/or 926 may operate distributed updating manager 1002 and/or feedback receiving component 1006 to receive feedback, from network entity 910, associated with one or more network parameters of the base station. In an aspect, for example, the network parameters may be include transmit power of the base station, an antenna down tilt of the base station, and/or a frequency re-use factor of the base station.

Furthermore, at block 1106, methodology 1100 may include updating the one or more network parameters at the base station based on the feedback received from the network entity and local information at the base station. For example, in an aspect, base stations 922, 924, and/or 926 may operate distributed updating manager 1002 and/or feedback updating component 1008 to update the one or more network parameters at the base station based on the feedback received from the network entity and local information at the base station.

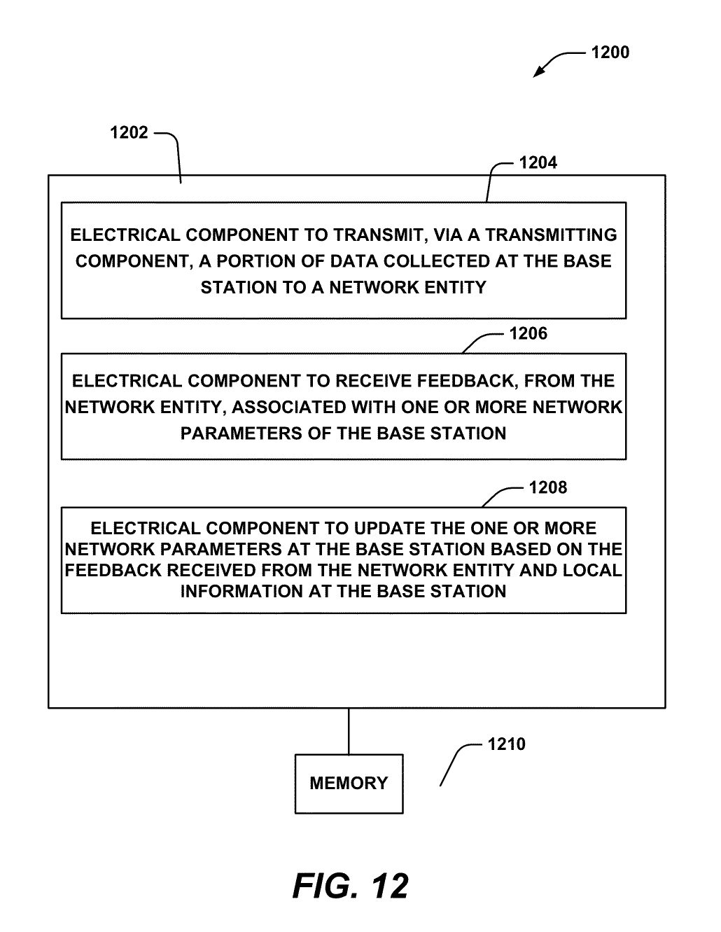

Referring to FIG. 12, an example system 1200 is displayed for distributed updating of a self organizing network. For example, system 1200 can reside at least partially within a base station, for example, base station 922, 924, and/or 926 (FIG. 9). It is to be appreciated that system 1200 is represented as including functional blocks, which can be functional blocks that represent functions implemented by a processor, software, or combination thereof (for example, firmware). System 1200 includes a logical grouping 1202 of electrical components that can act in conjunction. In an aspect, logical grouping 1202 can include an electrical component 1204 for transmitting a portion of data collected at the base station to a network entity, wherein the data collected at the base station is received by the base station from one or more user equipments (UE) in communication with one or more base stations, wherein the base station is one of the one or more base stations. In an aspect, electrical component 1204 may comprise data transmitting component 1004 (FIG. 10).

Further, logical grouping 1202 can include an electrical component 1206 for receiving feedback, from the network entity, associated with one or more network parameters of the base station, wherein the feedback received from the network entity is determined at the network entity at least based on the portion of data transmitted from the one or more base stations to the network entity. For example, in an aspect, electrical component 1206 may comprise feedback receiving component 1006 (FIG. 10).

Furthermore, logical grouping 1202 can include an electrical component 1208 for updating the one or more network parameters at the base station based on the feedback received from the network entity and local information at the base station. For example, in an aspect, electrical component 1208 may comprise parameter updating component 1008 (FIG. 10).

Additionally, system 1200 can include a memory 1210 that retains instructions for executing functions associated with the electrical components 1204, 1206, and 1208, stores data used or obtained by the electrical components 1204, 1206, and 1208, etc. While shown as being external to memory 1210, it is to be understood that one or more of the electrical components 1204, 1206, and 1208 can exist within memory 1210. In one example, electrical components 1204, 1206, and 1208 can comprise at least one processor, or each electrical component 1204, 1206, and 1208 can be a corresponding module of at least one processor. Moreover, in an additional or alternative example, electrical components 1204, 1206, and 1208 can be a computer program product including a computer readable medium, where each electrical component 1204, 1206, and 1208 can be corresponding code.

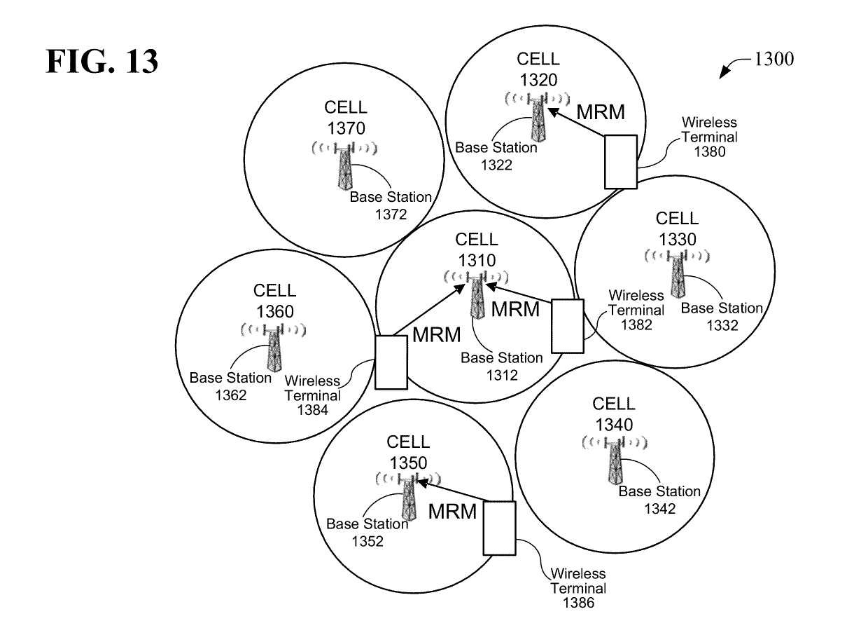

Referring next to FIG. 13, an example network that facilitates distributed updating of a self organizing network is provided. As illustrated, network 1300 includes a plurality of cells 1310, 1320, 1330, 1340, 1350, 1360, 1370, which are respectively served by base stations 1312, 1322, 1332, 1342, 1352, 1362, 1372 which can be base stations 922, 924, and/or 926 which may operate distributed updating manager 1002. In an aspect, coverage statistics ascertained by any of base stations 1312, 1322, 1332, 1342, 1352, 1362, 1372 are computed by analyzing MRMs provided by any of wireless terminals 1380, 1382, 1384, 1386. For instance, statistics computed by an eNB and exchanged with other eNBs can be a direct aggregation of measurements reported by UEs in MRMs. For example, such computations may include an average/max/min reported RSRP/RSRQ/RSSI of the serving cell, an average/max/min reported RSRP/RSRQ/RSSI of each neighbor, and/or an average/max/min transmit power of a UE.

In a further aspect, statistics computed by an eNB and exchanged with other eNBs can also be obtained by further analysis of MRMs. For this particular aspect, such computations may, for example, reflect average cell geometry, average path loss in the cell, average signal-to-noise ratio requirement of the UEs in the cell, and/or interference coefficients for each neighbor. Example computations of such parameters may include:

$${IC}_{i , j} = {{Average}_{over all MRMs}}_{recceived in cell i} ( \frac{{RSRP}_{j}}{{RSRP}_{1}} )$$

$${G}_{i} = {{Average}_{over all MRMs}}_{received in cell i} \frac{{\sum }_{j \neq i}^{ } {RSRP}_{j}}{{RSRP}_{1}}$$

$${PL}_{i} = {{Average}_{MRMs recceived}}_{in cell i} ( \frac{RST \times {Power}_{i}}{{RSRP}_{i}} )$$

$$where$$

$$RSRPi = RSRP of the cell i reported by UE in MRM \\ Gi = average geometry of cell i$$

$$ICi , j = interference coefficient of cell j to cell i$$

$$PLi = Average path loss in cell i , \\ and$$

$$RST \times Poweri = Transmit power of the Reference Signal in cell i$$

$$and$$

$$where any of ICi , j , Gi , PLi can be included in CSIi .$$

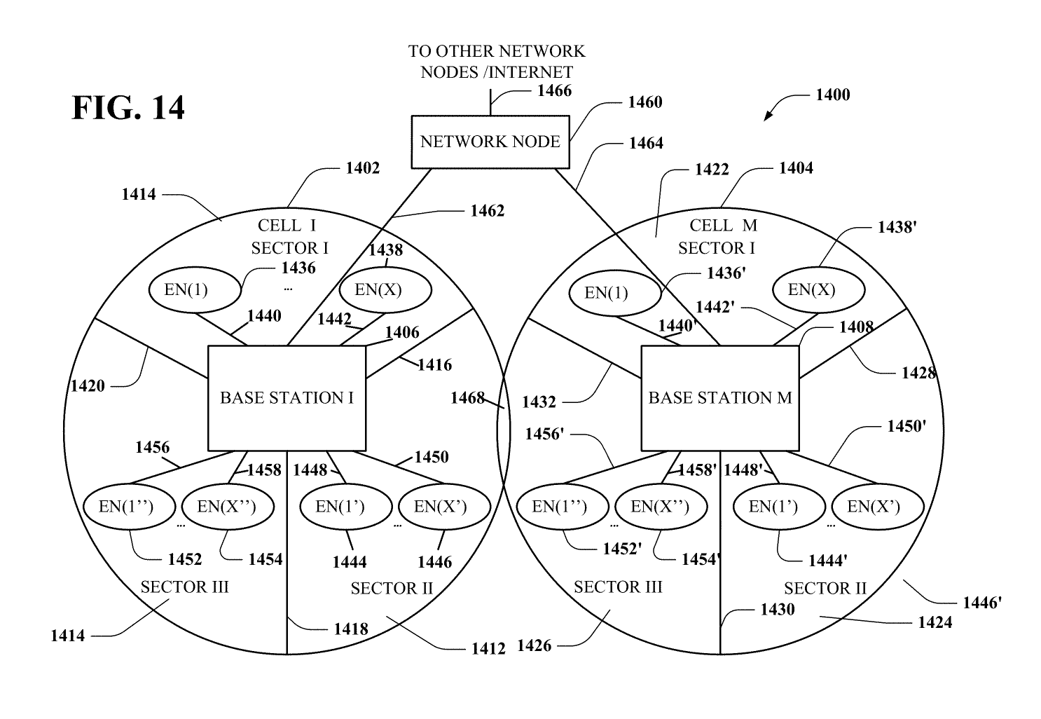

Referring next to FIG. 14, an example communication system 1400 implemented in accordance with various aspects is provided including multiple cells: cell 11402, cell M 1404 which may be respectively served by base stations I and M which can be base stations 922, 924, and/or 926 which may operate distributed updating manager 1002. Here, it should be noted that neighboring cells 1402, 1404 overlap slightly, as indicated by cell boundary region 1468, thereby creating potential for signal interference between signals transmitted by base stations in neighboring cells. Each cell 1402, 1404 of system 1400 includes three sectors. Cells which have not been subdivided into multiple sectors (N=1), cells with two sectors (N=2) and cells with more than 3 sectors (N>3) are also possible in accordance with various aspects. Cell 1402 includes a first sector, sector I 1414, a second sector, sector II 1412, and a third sector, sector III 1414. Each sector 1414, 1412, and 1414 has two sector boundary regions; each boundary region is shared between two adjacent sectors.

Sector boundary regions provide potential for signal interference between signals transmitted by base stations in neighboring sectors. Line 1416 represents a sector boundary region between sector I 1414 and sector II 1412; line 1418 represents a sector boundary region between sector II 1412 and sector III 1414; line 1420 represents a sector boundary region between sector III 1414 and sector 1 1414. Similarly, cell M 1404 includes a first sector, sector I 1422, a second sector, sector II 1424, and a third sector, sector III 1426. Line 1428 represents a sector boundary region between sector I 422 and sector II 1424; line 1430 represents a sector boundary region between sector II 424 and sector III 1426; line 1432 represents a boundary region between sector III 1426 and sector I 1422. Cell I 1402 includes a base station (BS), base station I 1406, and a plurality of end nodes (ENs) in each sector 1414, 1412, 1414. Sector I 1414 includes EN(1) 1436 and EN(X) 1438 coupled to BS 1406 via wireless links 1440, 1442, respectively; sector II 1412 includes EN(1′) 1444 and EN(X′) 1446 coupled to BS 1406 via wireless links 1448, 1450, respectively; sector III 1414 includes EN(1″) 1452 and EN(X″) 1454 coupled to BS 1406 via wireless links 1456, 1458, respectively. Similarly, cell M 1404 includes base station M 1408, and a plurality of end nodes (ENs) in each sector 1422, 1424, and 1426. Sector I 1422 includes EN(1) 1436′ and EN(X) 1438′ coupled to BS M 1408 via wireless links 1440′, 1442′, respectively; sector II 1424 includes EN(1′) 1444′ and EN(X′) 1446′ coupled to BS M 1408 via wireless links 1448′, 1450′, respectively; sector 3 1426 includes EN(1″) 1452′ and EN(X″) 1454′ coupled to BS 1408 via wireless links 1456′, 1458′, respectively.

System 1400 also includes a network node 1460 which is coupled to BS I 1406 and BS M 1408 via network links 1462, 1464, respectively. Network node 1460 is also coupled to other network nodes, e.g., other base stations, AAA server nodes, intermediate nodes, routers, etc. and the Internet via network link 1466. Network links 1462, 1464, 1466 may be, e.g., fiber optic cables. Each end node, e.g. EN 1 1436 may be a wireless terminal including a transmitter as well as a receiver. The wireless terminals, e.g., EN(1) 1436 may move through system 1400 and may communicate via wireless links with the base station in the cell in which the EN is currently located. The wireless terminals, (WTs), e.g. EN(1) 1436, may communicate with peer nodes, e.g., other WTs in system 1400 or outside system 1400 via a base station, e.g. BS 1406, and/or network node 1460. WTs, e.g., EN(1) 1436 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

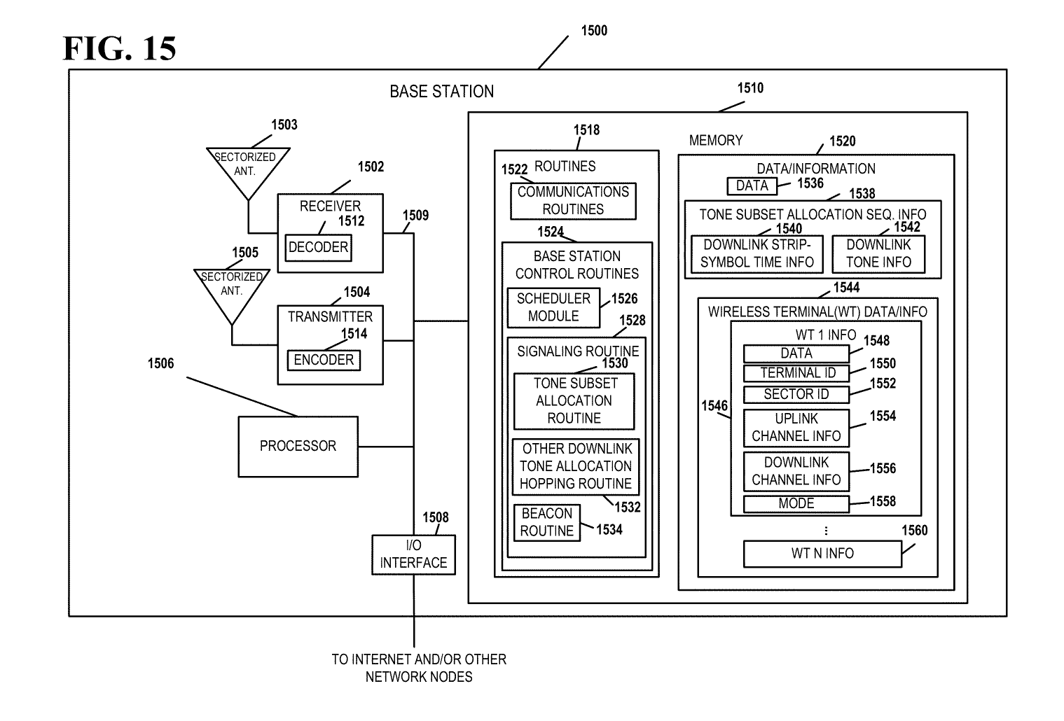

FIG. 15 illustrates an example base station 1500, in accordance with various aspects, which can be base station 922, 924, and/or 926 which may operate distributed updating manager 1002. Base station 1500 implements tone subset allocation sequences, with different tone subset allocation sequences generated for respective different sector types of the cell. Base station 1500 may be used as any one of base stations 1322, 1324, and/or 1326 of the system 900 of FIG. 9, and/or base station 1406 and/or 1408 of the system 1400 of FIG. 14. The base station 1500 includes a receiver 1502, a transmitter 1504, a processor 1506, e.g., CPU, an input/output interface 1508 and memory 1510 coupled together by a bus 1509 over which various elements 1502, 1504, 1506, 1508, and 1510 may interchange data and information.

Sectorized antenna 1503 coupled to receiver 1502 is used for receiving data and other signals, e.g., channel reports, from wireless terminals transmissions from each sector within the base station's cell. Sectorized antenna 1505 coupled to transmitter 1504 is used for transmitting data and other signals, e.g., control signals, pilot signal, beacon signals, etc. to wireless terminals 1200 (see FIG. 12) within each sector of the base station's cell. In various aspects, base station 1500 may employ multiple receivers 1502 and multiple transmitters 1504, e.g., an individual receivers 1502 for each sector and an individual transmitter 1504 for each sector. Processor 1506, may be, e.g., a general purpose central processing unit (CPU). Processor 1506 controls operation of base station 1500 under direction of one or more routines 1518 stored in memory 1510 and implements the methods. I/O interface 1508 provides a connection to other network nodes, coupling the BS 1500 to other base stations, access routers, AAA server nodes, etc., other networks, and the Internet. Memory 1510 includes routines 1518 and data/information 1520.

Data/information 1520 includes data 1536, tone subset allocation sequence information 1538 including downlink strip-symbol time information 1540 and downlink tone information 1542, and wireless terminal (WT) data/info 1544 including a plurality of sets of WT information: WT 1 info 1546 and WT N info 1560. Each set of WT info, e.g., WT 1 info 1546 includes data 1548, terminal ID 1550, sector ID 1552, uplink channel information 1554, downlink channel information 1556, and mode information 1558.

Routines 1518 include communications routines 1522 and base station control routines 1524. Base station control routines 1524 includes a scheduler module 1526 and signaling routines 1528 including a tone subset allocation routine 1530 for strip-symbol periods, other downlink tone allocation hopping routine 1532 for the rest of symbol periods, e.g., non strip-symbol periods, and a beacon routine 1534.

Data 1536 includes data to be transmitted that will be sent to encoder 1514 of transmitter 1504 for encoding prior to transmission to WTs, and received data from WTs that has been processed through decoder 1512 of receiver 1502 following reception. Downlink strip-symbol time information 1540 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1542 includes information including a carrier frequency assigned to the base station 1500, the number and frequency of tones, and the set of tone subsets to be allocated to the strip-symbol periods, and other cell and sector specific values such as slope, slope index and sector type.

Data 1548 may include data that WT1 1200 has received from a peer node, data that WT 1 1200 desires to be transmitted to a peer node, and downlink channel quality report feedback information. Terminal ID 1550 is a base station 1500 assigned ID that identifies WT 1 1200. Sector ID 1552 includes information identifying the sector in which WT1 1200 is operating. Sector ID 1552 can be used, for example, to determine the sector type. Uplink channel information 1554 includes information identifying channel segments that have been allocated by scheduler 1526 for WT1 1200 to use, e.g., uplink traffic channel segments for data, dedicated uplink control channels for requests, power control, timing control, etc. Each uplink channel assigned to WT1 1200 includes one or more logical tones, each logical tone following an uplink hopping sequence. Downlink channel information 1556 includes information identifying channel segments that have been allocated by scheduler 1526 to carry data and/or information to WT1 1200, e.g., downlink traffic channel segments for user data. Each downlink channel assigned to WT1 1200 includes one or more logical tones, each following a downlink hopping sequence. Mode information 1558 includes information identifying the state of operation of WT1 1200, e.g. sleep, hold, on.

Communications routines 1522 control the base station 1500 to perform various communications operations and implement various communications protocols. Base station control routines 1524 are used to control the base station 1500 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1528 controls the operation of receiver 1502 with its decoder 1512 and transmitter 1504 with its encoder 1514. The signaling routine 1528 is responsible controlling the generation of transmitted data 1536 and control information. Tone subset allocation routine 1530 constructs the tone subset to be used in a strip-symbol period using the method of the aspect and using data/info 1520 including downlink strip-symbol time info 1540 and sector ID 1552. The downlink tone subset allocation sequences will be different for each sector type in a cell and different for adjacent cells. The WTs 1200 receive the signals in the strip-symbol periods in accordance with the downlink tone subset allocation sequences; the base station 1500 uses the same downlink tone subset allocation sequences in order to generate the transmitted signals. Other downlink tone allocation hopping routine 1532 constructs downlink tone hopping sequences, using information including downlink tone information 1542, and downlink channel information 1556, for the symbol periods other than the strip-symbol periods. The downlink data tone hopping sequences are synchronized across the sectors of a cell. Beacon routine 1534 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

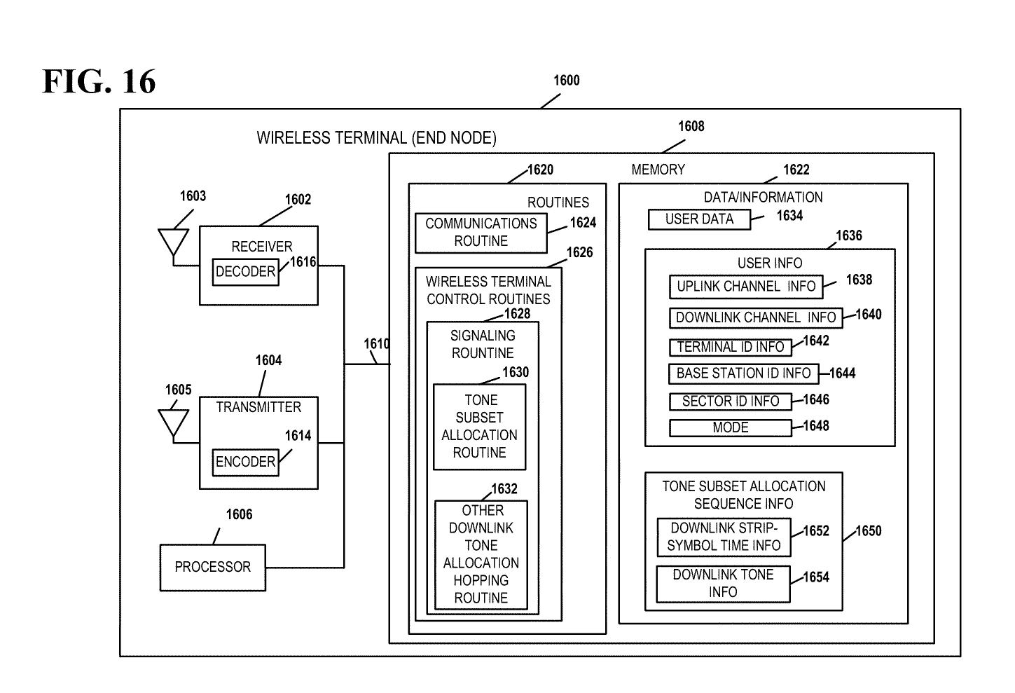

FIG. 16 illustrates an example wireless terminal (end node) 1600 which can be used as any one of the wireless terminals (end nodes), e.g., EN(1) 1436, of the system 1400 shown in FIG. 14 which can be UEs 942, 044, and/or 946 in communication with base stations 922, 924, and/or 926 which may operate distributed updating manager 1002. In an aspect, EN(1) 1436 may be UE 1342, 1344, and/or 1346. Wireless terminal 1600 implements the tone subset allocation sequences. The wireless terminal 1600 includes a receiver 1602 including a decoder 1616, a transmitter 1604 including an encoder 1614, a processor 1606, and memory 1608 which are coupled together by a bus 1610 over which the various elements 1602, 1604, 1606, 1608 can interchange data and information. An antenna 1603 used for receiving signals from a base station (and/or a disparate wireless terminal) is coupled to receiver 1602. An antenna 1605 used for transmitting signals, e.g., to a base station (and/or a disparate wireless terminal) is coupled to transmitter 1604.

The processor 1606, e.g., a CPU controls the operation of the wireless terminal 1600 and implements methods by executing routines 1620 and using data/information 1622 in memory 1608.

Data/information 1622 includes user data 1634, user information 1636, and tone subset allocation sequence information 1650. User data 1634 may include data, intended for a peer node, which will be routed to encoder 1614 for encoding prior to transmission by transmitter 1604 to a base station, and data received from the base station which has been processed by the decoder 1616 in receiver 1602. User information 1636 includes uplink channel information 1638, downlink channel information 1640, terminal ID information 1642, base station ID information 1644, sector ID information 1646, and mode information 1648. Uplink channel information 1638 includes information identifying uplink channels segments that have been assigned by a base station for wireless terminal 1600 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 1640 includes information identifying downlink channel segments that have been assigned by a base station to WT 1600 for use when the base station is transmitting data/information to WT 1600. Downlink channels may include downlink traffic channels and assignment channels, each downlink channel including one or more logical tone, each logical tone following a downlink hopping sequence, which is synchronized between each sector of the cell.

User info 1636 also includes terminal ID information 1642, which is a base station-assigned identification, base station ID information 1644 which identifies the specific base station that WT has established communications with, and sector ID info 1646 which identifies the specific sector of the cell where WT 1600 is presently located. Base station ID 1644 provides a cell slope value and sector ID info 1646 provides a sector index type; the cell slope value and sector index type may be used to derive tone hopping sequences. Mode information 1648 also included in user info 1636 identifies whether the WT 1600 is in sleep mode, hold mode, or on mode.

Tone subset allocation sequence information 1650 includes downlink strip-symbol time information 1652 and downlink tone information 1654. Downlink strip-symbol time information 1652 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1654 includes information including a carrier frequency assigned to the base station, the number and frequency of tones, and the set of tone subsets to be allocated to the strip-symbol periods, and other cell and sector specific values such as slope, slope index and sector type.

Routines 1620 include communications routines 1624 and wireless terminal control routines 1626. Communications routines 1624 control the various communications protocols used by WT 1600. Wireless terminal control routines 1626 controls basic wireless terminal 1600 functionality including the control of the receiver 1602 and transmitter 1604. Wireless terminal control routines 1626 include the signaling routine 1628. The signaling routine 1628 includes a tone subset allocation routine 1630 for the strip-symbol periods and an other downlink tone allocation hopping routine 1632 for the rest of symbol periods, e.g., non strip-symbol periods. Tone subset allocation routine 1630 uses user data/info 1622 including downlink channel information 1640, base station ID info 1644, e.g., slope index and sector type, and downlink tone information 1654 in order to generate the downlink tone subset allocation sequences in accordance with some aspects and process received data transmitted from the base station. Other downlink tone allocation hopping routine 1630 constructs downlink tone hopping sequences, using information including downlink tone information 1654, and downlink channel information 1640, for the symbol periods other than the strip-symbol periods. Tone subset allocation routine 1630, when executed by processor 1606, is used to determine when and on which tones the wireless terminal 1600 is to receive one or more strip-symbol signals from the base station 1100. The uplink tone allocation hopping routine 1630 uses a tone subset allocation function, along with information received from the base station, to determine the tones in which it should transmit on.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the aspects are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more aspects. It is, of course, not possible to describe every conceivable combination of components or methodologies for purposes of describing the aforementioned aspects, but one of ordinary skill in the art may recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method for distributed updating of a self organizing network, comprising:
transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations;
receiving feedback, from the network entity, associated with one or more network parameters of the base station, wherein the feedback received from the network entity is determined at the network entity at least based on the portion of data transmitted from the one or more base stations to the network entity; and
updating the one or more network parameters at the base station based on the feedback received from the network entity and local information at the base station.

2. The method of claim 1, wherein the one or more network parameters comprise at least one of a transmit power of the base station, an antenna down tilt of the base station, and a frequency re-use factor.

3. The method of claim 1, wherein the feedback for the one or more network parameters comprises at least one of a minimum value, a maximum value, and a range.

4. The method of claim 3, wherein the minimum values for the one or more network parameters are determined by the network entity in response to detecting coverage gaps in the self organizing network based at least on the portion of data transmitted from the one or more base stations.

5. The method of claim 3, further comprising setting a transmit power of the base station to a value based on the minimum value and data collected at the base station from the one or more UEs.

6. The method of claim 5, wherein the data collected at the base station comprises one or more of a number of UEs camped on the base station, a location of the UEs camped on the base station, a signal to interference plus noise ratios (SINR) of the one or more UEs camped on the base station, and a path loss of the one or more UEs to the base station.

7. The method of claim 1, wherein updating the one or more network parameters based on the local information at the base station includes updating the one or more network parameters based on information at the base station related to one or more of pilot pollution, call failures, and handover failures.

8. An apparatus for distributed updating of a self organizing network, comprising:
means for transmitting a portion of data collected at the base station to a network entity, wherein the data collected at the base station is received by the base station from one or more user equipments (UE) in communication with one or more base stations, wherein the base station is one of the one or more base stations;
means for receiving feedback, from the network entity, associated with one or more network parameters of the base station, wherein the feedback received from the network entity is determined at the network entity at least based on the portion of data transmitted from the one or more base stations to the network entity; and
means for updating the one or more network parameters at the base station based on the feedback received from the network entity and local information at the base station.

9. The apparatus of claim 8, wherein the one or more network parameters comprise at least one of a transmit power of the base station, an antenna down tilt of the base station, and a frequency re-use factor.

10. The apparatus of claim 8, wherein the feedback for the one or more network parameters comprises at least one of a minimum value, a maximum value, and a range.

11. The apparatus of claim 10, wherein the minimum values for the one or more network parameters are determined by the network entity in response to detecting coverage gaps in the self organizing network based at least on the portion of data transmitted from the one or more base stations.

12. The apparatus of claim 10, further comprising means for setting a transmit power of the base station to a value based on the minimum value and data collected at the base station from the one or more UEs.

13. The apparatus of claim 12, wherein the data collected at the base station comprises one or more of a number of UEs camped on the base station, a location of the UEs camped on the base station, a signal to interference plus noise ratios (SINR) of the one or more UEs camped on the base station, and a path loss of the one or more UEs to the base station.

14. A computer program product for distributed updating of a self organizing network, comprising a non-transitory computer-readable medium comprising code executable by a computer for:
transmitting, via a transmitting component at a base station, a portion of data collected at the base station to a network entity, wherein the data collected at the base station is received by the base station from one or more user equipments (UE) in communication with one or more base stations, wherein the base station is one of the one or more base stations;
receiving feedback, from the network entity, associated with one or more network parameters of the base station, wherein the feedback received from the network entity is determined at the network entity at least based on the portion of data transmitted from the one or more base stations to the network entity; and
updating the one or more network parameters at the base station based on the feedback received from the network entity and local information at the base station.

15. The computer program product of claim 14, wherein the one or more network parameters comprise at least one of a transmit power of the base station, an antenna down tilt of the base station, and a frequency re-use factor.

16. The computer program product of claim 14, wherein the feedback for the one or more network parameters comprises at least one of a minimum value, a maximum value, and a range.

17. The computer program product of claim 16, wherein the minimum values for the one or more network parameters are determined by the network entity in response to detecting coverage gaps in the self organizing network based at least on the portion of data transmitted from the one or more base stations.

18. The computer program product of claim 16, further comprising code for setting a transmit power of the base station to a value based on the minimum value and data collected at the base station from the one or more UEs.

19. The computer program product of claim 18, wherein the data collected at the base station comprises one or more of a number of UEs camped on the base station, a location of the UEs camped on the base station, a signal to interference plus noise ratios (SINR) of the one or more UEs camped on the base station, and a path loss of the one or more UEs to the base station.

20. An apparatus for distributed updating of a self organizing network, comprising:
a data transmitting component to transmit a portion of data collected at the base station to a network entity, wherein the data collected at the base station is received by the base station from one or more user equipments (UE) in communication with one or more base stations, wherein the base station is one of the one or more base stations;
a feedback receiving component to receive feedback, from the network entity, associated with one or more network parameters of the base station, wherein the feedback received from the network entity is determined at the network entity at least based on the portion of data transmitted from the one or more base stations to the network entity; and
a parameter updating component to update the one or more network parameters at the base station based on the feedback received from the network entity and local information at the base station.

21. The apparatus of claim 20, wherein the parameter updating component is configured to update the one or more network parameters that includes at least one of a transmit power of the base station, an antenna down tilt of the base station, and a frequency re-use factor.

22. The apparatus of claim 20, wherein the feedback receiving component is configured to receive the feedback that includes at least one of a minimum value, a maximum value, and a range.

23. The apparatus of claim 22, wherein the minimum values for the one or more network parameters are determined by the network entity in response to detecting coverage gaps in the self organizing network based at least on the portion of data transmitted from the one or more base stations.

24. The apparatus of claim 22, wherein the parameter updating component is configured to update a transmit power of the base station to a value based on the minimum value and data collected at the base station from the one or more UEs.

25. The apparatus of claim 24, wherein the data collected at the base station comprises one or more of a number of UEs camped on the base station, a location of the UEs camped on the base station, a signal to interference plus noise ratios (SINR) of the one or more UEs camped on the base station, and a path loss of the one or more UEs to the base station.

26. The apparatus of claim 20, wherein the parameter updating component is configured to update the one or more network parameters based on the local information at the base station that includes information at the base station related to one or more of pilot pollution, call failures, and handover failures.
